(19) United States
(12) Patent Application Publication
(10) Pub. No.: US 2007/0152554 A1
(43) Pub. Date: Jul. 5, 2007

(54) Illuminating device

(76) Inventors: Sun-Il Kim, Suwon-si (KR); Deuk-Seok Chung, Seongnam-si (KR); Byong-gwon Song, Seoul (KR); Shang-Hyeun Park, Boryeong-si (KR); Moon-Jin Shin, Yongin-si (KR)

Correspondence Address: Robert E. Bushnell, Suite 300, 1522 K Street, N.W., Washington, DC, 20005-1202, US

(21) Appl. No.: 11/580,062

(22) Filed: Oct. 13, 2006

(30) Foreign Application Priority Data
Jan. 4, 2006 (KR) 10-2006-0000888

(51) Int. Cl. H01J 19/02; H01J 1/62

(52) U.S. Cl. 313/112; 313/495

(57) ABSTRACT

An illuminating device includes: an upper substrate and a lower substrate facing each other and spaced apart from each other; an anode electrode arranged on a lower surface of the upper substrate; a phosphor layer arranged on a lower surface of the anode electrode; a cathode electrode arranged on an upper surface of the lower substrate; an electron emission source arranged on the cathode electrode; and a reflection film arranged between the electron emission source and the phosphor layer and respectively separated therefrom, the reflection film being patterned on a surface facing the phosphor layer to diffuse light emitted from the phosphor layer. The illuminating device provides improved brightness uniformity by forming a pattern on the reflection film so that light can be uniformly diffused or dispersed.

### CLAIM OF PRIORITY

This application makes reference to, incorporates the same herein, and claims all benefits accruing under 35 U.S.C. §119 from an application for ILLUMINATING DEVICE FOR DISPLAY APPARATUS, BACKLIGHT UNIT INCLUDING THE SAME AND LIQUID CRYSTAL DISPLAY USING THE BACKLIGHT UNIT earlier filed in the Korean Intellectual Property Office on Jan. 4, 2006 and there duly assigned Serial No. 10-2006-0000888.

### BACKGROUND OF THE INVENTION

1. Field of the Invention

The present invention relates to an illuminating device, and more particularly, to an illuminating device that increases the brightness uniformity of a display device.

2. Description of the Related Art

Generally, non-emissive display devices, such as Liquid Crystal Displays (LCDs) need an additional illuminating device, such as a backlight unit.

Backlight units generally use Cold Cathode Fluorescent Lamps (CCFLs) as a line luminescence source and Light Emitting Diodes (LEDs) as a point luminescence source. However, such backlight units have high manufacturing costs due to their structural complexity, and have high power consumption due to reflection and transmittance of light since the light source is located at a side of the backlight unit. In particular, as the size of an LCD device increases, it becomes more difficult to obtain uniform brightness.

Accordingly, to address the above problems, a field emission backlight unit having a planar emission structure has been proposed. The field emission backlight unit has lower power consumption compared to a backlight unit that uses a CCFL and also has a relatively uniform brightness in a wide range of light emission regions.

To obtain a relatively uniform brightness, an LCD includes a light diffusion element. To increase the light diffusion effect, a plurality of diffusion plates and/or diffusion films are placed between the light diffusion element and the liquid crystal panel. However, when the diffusion plates and/or the diffusion films are used, a loss of brightness occurs due to light reflection and absorption of the diffusion plates and/or the diffusion films. Accordingly, a higher level of brightness uniformity is required as compared to conventional diffusion plates and/or diffusion films.

Carbon Nanotubes (CNTs) are grown in a tube-shape having hollows of a few nanometers, and are named according to this characteristic. CNTs are formed as a thin film to be used as a tip device for a field effect display or an anode of a fuel cell or a secondary cell.

In a Carbon Nanotube-Backlight Unit (CNT-BLU), electrons emitted from an electron emission source, such as CNTs, excite red, green, and blue phosphor materials to emit light. The light emitted from the phosphor materials proceeds toward the front to reach an observer and the rest of the emitted light is lost. As a method of minimizing the loss of light, a metal reflection film formed of a material, such as aluminum, is formed at a predetermined distance below the phosphor material to reflect the light that proceeds backward from the phosphor material. However, due to the characteristic of the phosphor material that emits light as dots, it is difficult to obtain light having uniform brightness. Accordingly, the non-uniformity of brightness is still a problem that must be solved.

### SUMMARY OF THE INVENTION

The present invention provides an illuminating device that increases the brightness uniformity of a display device.

According to an aspect of the present invention, an illuminating device is provided including: an upper substrate and a lower substrate facing each other and spaced apart from each other; an anode electrode arranged on a lower surface of the upper substrate; a phosphor layer arranged on a lower surface of the anode electrode; a cathode electrode arranged on an upper surface of the lower substrate; an electron emission source arranged on the cathode electrode; and a reflection film arranged between the electron emission source and the phosphor layer and respectively separated therefrom, the reflection film being patterned on a surface facing the phosphor layer to diffuse light emitted from the phosphor layer.

The pattern of the reflection film preferably includes an uneven pattern. The pattern of the reflection film preferably includes a fine pattern having a shape selected from a group consisting of a semi-spherical shape, a rectangular shape, a triangular shape, and an oval shape. The pattern of the reflection film preferably includes a holographic pattern. The reflection film is preferably separated from the phosphor layer by a distance in a range of 0.5 to 1 μm. The reflection film preferably includes an Al film.

The electron emission source preferably includes Carbon Nanotubes (CNTs).

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of a Carbon Nanotube-Backlight Unit (CNT-BLU);

FIG. 2 is schematic cross-sectional view of a CNT-BLU that includes an Al reflection film;

FIG. 3 is a schematic cross-sectional view of a CNT-BLU that includes a reflection film having a pattern according to an embodiment of the present invention;

FIG. 4A is a view of a method of forming a diffusion plate pattern;

FIG. 4B is a photograph (POC20 of POC Co.) of the surface of a diffusion plate where a pattern is formed using the method of FIG. 4A; and

FIG. 5 is a view of a method of manufacturing a reflection film having a diffusion plate according to an embodiment of the present invention.

### DETAILED DESCRIPTION OF THE INVENTION

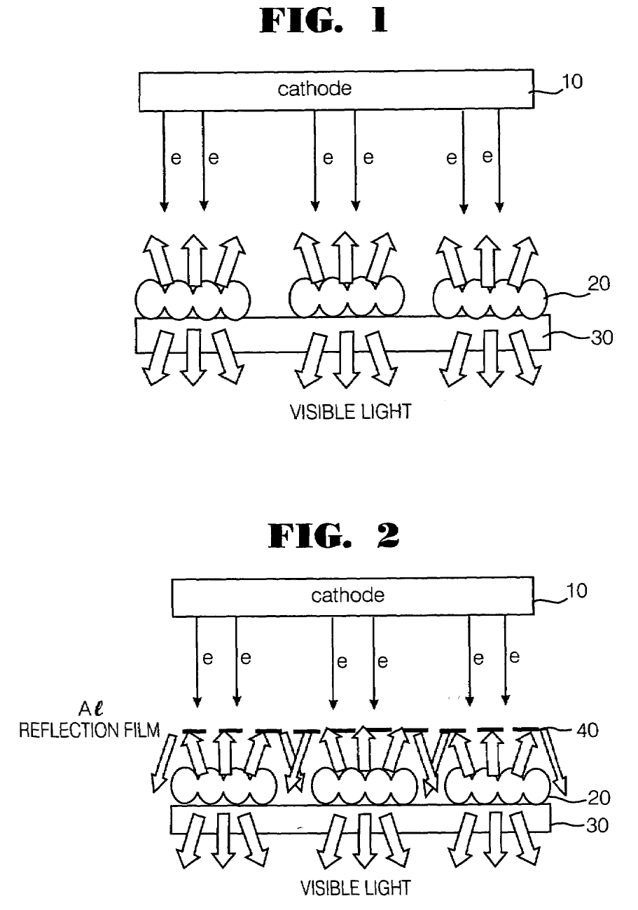

Referring to FIG. 1, electrons emitted from an electron emission source, such as Carbon Nanotubes (CNTs), excite red, green, and blue phosphor materials to emit light. The light emitted from the phosphor materials proceeds toward the front to reach an observer and the rest of the emitted light is lost. As a method of minimizing the loss of light, as depicted in FIG. 2, a metal reflection film formed of a material, such as aluminum, is formed at a predetermined distance below the phosphor material to reflect the light that proceeds backward from the phosphor material. However, due to the characteristic of the phosphor material that emits light as dots, it is difficult to obtain light having uniform brightness. Accordingly, the non-uniformity of brightness is still a problem that must be solved.

The present invention is described more fully below with reference to the accompanying drawings in which exemplary embodiments of the present invention are shown.

The present invention provides illuminating device including: an upper substrate and a lower substrate facing each other and spaced apart from each other; an anode electrode arranged on a lower surface of the upper substrate; a phosphor layer arranged on a lower surface of the anode electrode; a cathode electrode arranged on an upper surface of the lower substrate; an electron emission source arranged on the cathode electrode; and a reflection film arranged between the electron emission source and the phosphor layer and respectively separated therefrom, the reflection film being patterned on a surface facing the phosphor layer to diffuse light emitted from the phosphor layer. The illuminating device provides improved brightness uniformity by forming a pattern on the reflection film so that light can be uniformly diffused or dispersed.

FIG. 3 is a schematic cross-sectional view of an illuminating device for a display apparatus that includes a reflection film having a pattern according to an embodiment of the present invention.

Referring to FIG. 3, an upper substrate (not shown) and a lower substrate (not shown) are disposed apart from each other. A cathode electrode 10 is formed on the lower substrate, and an electron emission source (not shown) is formed on the cathode electrode 10. An anode electrode 30 is formed on a lower surface of the upper substrate, and a phosphor layer 20 is formed on the anode electrode 30. A reflection film 50 having a predetermined pattern is disposed between the electron emission source and the phosphor layer 20. The reflection film 50 has openings having a predetermined gap therebetween as with the reflection film 40 of FIG. 2.

When a predetermined voltage is supplied to the cathode electrode 10 and the anode electrode 30, electrons are emitted from an electron emission source (not shown) and are moved to the phosphor layer 20 toward the anode electrode 30 through the openings of the reflection film 50. That is, the electrons emitted from the electron emission source on the cathode electrode 10 form an electron beam that collides with the phosphor layer 20. Accordingly, red, green, and blue phosphor materials of the phosphor layer 20 are excited and emit white visible light. A portion of light proceeding toward the lower substrate is reflected by the reflection film 50, and then proceeds toward the front face, i.e., the upper substrate. The light is spread at diffusion angles by the pattern formed on the reflection film 50. Therefore, brightness uniformity higher than that of the case without the reflection film 50 can be achieved. Conventionally, an Al reflection film is used for increasing brightness in display devices, such as CRTs. However, in the present invention, the main object is to increase the uniformity of brightness by forming a pattern on the reflection film 50.

The pattern of the reflection film 50 can be a pattern applied to a common diffusion plate or a light guide plate, that is, a regular and/or irregular uneven pattern.

The uneven pattern can be a fine pattern having a structured surface. The fine pattern can be an embossed or engraved pattern having a semi-spherical shape, rectangular shape, triangular shape, or oval shape. The uneven pattern can be formed in a way that a unit pattern is periodically arranged up and down and left and right without gaps, or convex units, each having a random shape or dimension can be randomly disposed.

The pattern can be manufactured using injection molding, or by thermally pressing an existing sheet-shaped film, specifically, using a stamping method. In addition to these methods, the pattern can be obtained by hardening a film on which a thermal or ultraviolet ray-curable acryl or the same material as the substrate is attached, or can be obtained by performing non-uniform sand-blasting on the entire film.

Also, methods of forming the pattern include a method of forming a light diffusion ink pattern using screen printing, a method of injection-molding using a transfer film, an injection-molding method using a mold processed to have an uneven surface, a method of directly patterning a light diffusion pattern in a reflection film obtained through injection-molding, etc.

The reflection film that has the fine pattern having a structured surface can be manufactured using a hot embossing method by which a fine pattern is formed by hot pressing a master and a base film, and an ultraviolet hardening embossing method in which, after an ultraviolet ray curable paint (photopolymer) is coated on a master and a surface of a base film is pressed, the fine pattern is transferred to the base film by irradiating ultraviolet rays.

For mass production, a roll-to-roll type embossing type is widely used. In the roll type ultraviolet ray hardening method, a photopolymer which is an ultraviolet ray curable paint is coated on a base film, and then a surface of the base film is pressed using a master roll on which a pattern is formed, at the same time, the surface of the base film is hardened using an ultraviolet ray hardener. In the case of roll-to-roll type hot embossing, a stamp roller having a surface with a fine pattern that is a self-heat generator including a heater, and a pressing roller are placed to face each other, and then, the base film is passed between the two rollers so that the fine pattern is transferred to the base film through thermal pressing.

Also, the uneven pattern can be a holographic pattern. The holographic pattern can be manufactured using a typical method of manufacturing a holographic diffusion plate as follows.

First, a negative plate is formed. To manufacture the negative plate, a photresist is formed on an upper surface of a glass plate. Next, after a spacer having a predetermined thickness is formed on the photoresist and an inter glass plate is formed on the entire front surface, the photoresist where the spacer is not formed is photosensitized using a laser. The glass plate and photoresist structure, from which the inter glass plate and the spacer are removed, is developed using a developing solution to remove the exposed photoresist. As a result, the negative plate having a random uneven pattern is formed.

A method of manufacturing the holographic pattern is as follows. After a thin silver film is coated on the negative plate, a nickel plate having the same uneven pattern as the negative plate is formed using an electroplating method. After the silver film is separated from the negative plate, a nickel stamper having an opposite uneven pattern to the negative plate is formed on the nickel plate using an electroplating method. Then, the nickel plate is separated. A structure in which a glass plate and an ultraviolet ray curable resin layer are stacked is placed on a heater, the nickel stamper is placed on the resin layer and then impressed by a roller at a temperature higher than the glass transition temperature of the resin layer. Next, after the structure and the nickel stamper are reversed so that the nickel stamper can be located on the heater, the random uneven pattern is duplicated on the negative plate by hardening the resin layer by applying ultraviolet rays from an ultraviolet ray lamp through the glass plate. Next, the nickel stamper is separated. After another ultraviolet ray curable resin layer having a different refractive index from the resin layer is formed on the upper surface of the resultant product, from which the nickel stamper is removed, to planarize the surface thereof, the resin layer is hardened by applying ultraviolet rays from an ultraviolet ray lamp. This resin layer can have a greater refractive index than the former resin layer.

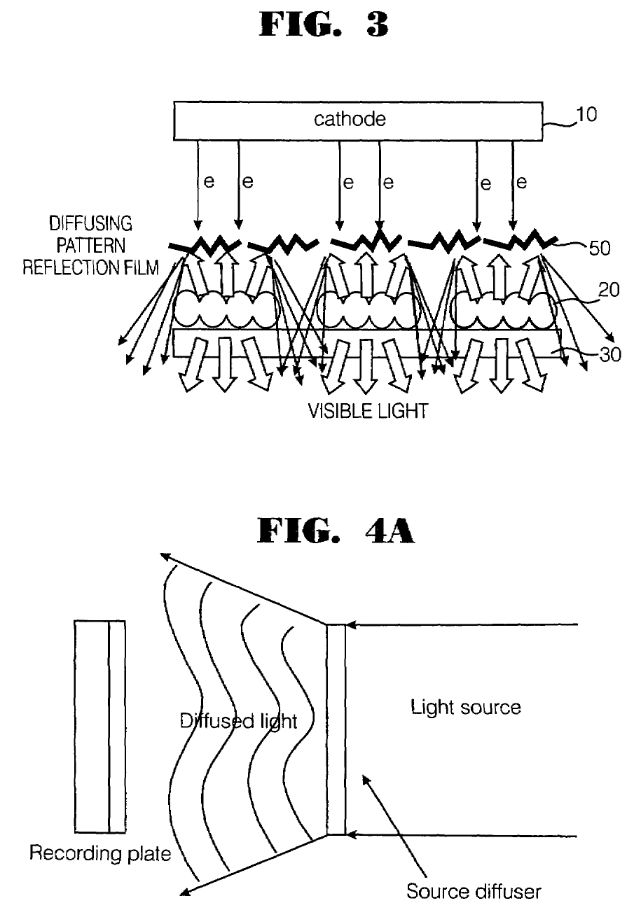

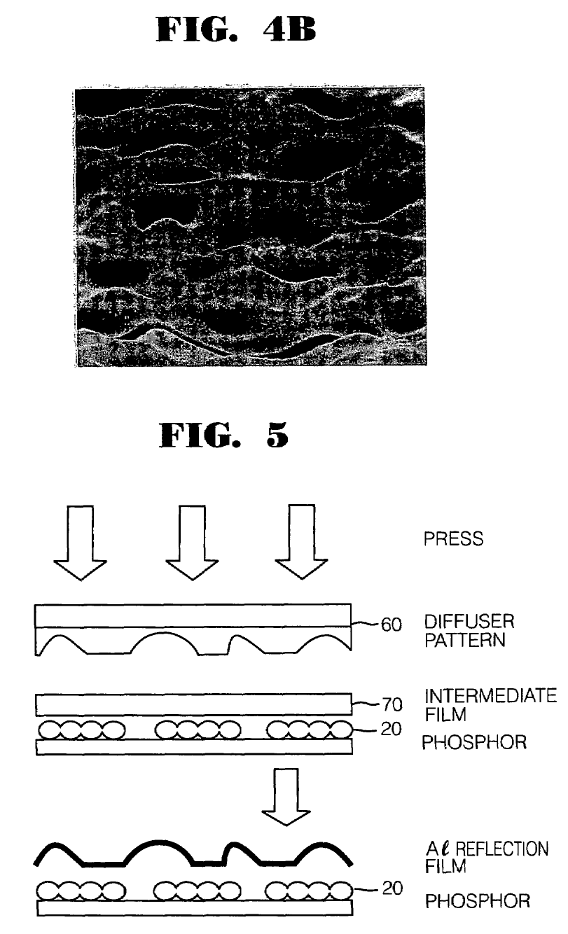

FIG. 4A is a view of a method of forming a diffusion plate pattern, and FIG. 4B is a photograph (POC20 of POC Co.) of the surface of a diffusion plate where a pattern is formed using the method of FIG. 4A, that is, a photograph of a holographic diffusion pattern formed on a diffusion plate.

FIG. 5 is a view of a method of manufacturing a reflection film having a pattern according to an embodiment of the present invention. After a master is manufactured using a photoresist having an appropriate diffusion angle using the method of manufacturing a holographic diffusion pattern of FIG. 4A, the pattern on the reflection film in FIG. 5 is formed using the master. To form the reflection film 50 a predetermined distance apart from an upper part of the phosphor layer 20, an intermediate film 70 is formed above the phosphor layer 20; a surface of the intermediate film 70 is formed in an uneven surface by pressing a diffusion plate master pattern 60; and a metal, such as Al, is deposited on the uneven surface, thereby forming a structure according to the present invention. The intermediate film 70 is then baked to be removed through vaporization.

CNTs can be used as the electron emission source. CNTs have an advantage of emitting electrons at a relatively lower driving voltage. Also, when paste CNTs or functional CNTs are used, a backlight unit with a large area can be manufactured, since a CNT emitter can be readily formed on a wide substrate. Furthermore, a large area backlight unit is further easily manufactured since the anode and cathode electrodes can be formed as a thick film instead of a thin film, thereby improving the economy of the display.

The reflection film can be separated approximately 0.5 to 1 μm from the phosphor layer. Brightness is reduced when the reflection film is separated less than 0.5 μm, and an arc due to floating electrons can occur when the reflection film is separated more than 1 μm.

The reflection film can be an Al film.

The illuminating device for a display device according to the present invention does not use a diffusion plate or a diffusion film. Accordingly, the reflection and absorption of light caused by the diffusion plate or the diffusion film do not occur. Therefore, the illuminating device according to the present invention can increase brightness of a display apparatus as compared to an illuminating device that uses a reflection film without a pattern, and also, its size can be significantly reduced.

The present invention can be applied not only to Liquid Crystal Displays (LCDs) but also to various electronic devices that require a backlight unit, such as laptop computers, electronic calculators, digital camcorders, etc.

Hereinafter, the present invention is described in greater detail with reference to the following example. The following example is for illustrative purposes only and is not intended to limit the scope of the present invention.

After coating a photoresist on a recording negative plate, the photoresist was exposed with an intensity of approximately 13 mJ/cm². A master having a pattern was manufactured by developing and washing the resultant product. An intermediate film was formed a predetermined distance above from a phosphor layer. A surface of the intermediate film was formed into an uneven surface by pressing the diffusion plate master pattern. Afterward, a reflection film having a pattern was formed by depositing a metal, such as Al. The intermediate film was removed by baking the resultant product at a temperature of approximately 450° for 30 minutes to vaporize the intermediate film.

The illuminating device for a display apparatus according to the present invention improves uniformity of brightness by forming a pattern on a reflection film so that light can be diffused or dispersed with uniform illumination.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. An illuminating device, comprising:
an upper substrate and a lower substrate facing each other and spaced apart from each other;
an anode electrode arranged on a lower surface of the upper substrate;
a phosphor layer arranged on a lower surface of the anode electrode;
a cathode electrode arranged on an upper surface of the lower substrate;
an electron emission source arranged on the cathode electrode; and
a reflection film arranged between the electron emission source and the phosphor layer and respectively separated therefrom, the reflection film being patterned on a surface facing the phosphor layer to diffuse light emitted from the phosphor layer.

2. The illuminating device of claim 1, wherein the pattern of the reflection film comprises an uneven pattern.

3. The illuminating device of claim 2, wherein the pattern of the reflection film comprises a fine pattern having a shape selected from a group consisting of a semi-spherical shape, a rectangular shape, a triangular shape, and an oval shape.

4. The illuminating device of claim 2, wherein the pattern of the reflection film comprises a holographic pattern.

5. The illuminating device of claim 1, wherein the electron emission source comprises Carbon Nanotubes (CNTs).

6. The illuminating device of claim 1, wherein the reflection film is separated from the phosphor layer by a distance in a range of 0.5 to 1 μm.

7. The illuminating device of claim 1, wherein the reflection film comprises an Al film.

8. A backlight unit including an illuminating device comprising:
an upper substrate and a lower substrate facing each other and spaced apart from each other;
an anode electrode arranged on a lower surface of the upper substrate;
a phosphor layer arranged on a lower surface of the anode electrode;
a cathode electrode arranged on an upper surface of the lower substrate;
an electron emission source arranged on the cathode electrode; and
a reflection film arranged between the electron emission source and the phosphor layer and respectively separated therefrom, the reflection film being patterned on a surface facing the phosphor layer to diffuse light emitted from the phosphor layer.

9. The backlight unit of claim 8, wherein the pattern of the reflection film comprises an uneven pattern.

10. The backlight unit of claim 8, wherein the electron emission source comprises Carbon Nanotubes (CNTs).

11. The backlight unit of claim 8, wherein the reflection film is separated from the phosphor layer by a distance in a range of 0.5 to 1 μm.

12. The backlight unit of claim 8, wherein the reflection film comprises an Al film.

13. A liquid crystal display including a backlight unit having an illuminating device comprising:
an upper substrate and a lower substrate facing each other and spaced apart from each other;
an anode electrode arranged on a lower surface of the upper substrate;
a phosphor layer arranged on a lower surface of the anode electrode;
a cathode electrode arranged on an upper surface of the lower substrate;
an electron emission source arranged on the cathode electrode; and
a reflection film arranged between the electron emission source and the phosphor layer and respectively separated therefrom, the reflection film being patterned on a surface facing the phosphor layer to diffuse light emitted from the phosphor layer.

14. The liquid crystal display of claim 13, wherein the pattern of the reflection film comprises an uneven pattern.

15. The liquid crystal display of claim 13, wherein the electron emission source comprises Carbon Nanotubes (CNTs).

16. The liquid crystal display of claim 13, wherein the reflection film is separated from the phosphor layer by a distance in a range of 0.5 to 1 μm.

17. The liquid crystal display of claim 13, wherein the reflection film comprises an Al film.
